(19) United States
(12) Patent Application Publication
(10) Pub. No.: US 2026/0029329 A1
(43) Pub. Date: Jan. 29, 2026

(54) METHOD TO MEASURE LIGHT LOSS OF ANISOTROPIC CRYSTAL SUBSTRATE

(71) Applicant: Applied Materials, Inc., Santa Clara, CA (US)

(72) Inventors: Yupeng ZHU, San Jose, CA (US); Jinxin FU, Fremont, CA (US)

(21) Appl. No.: 19/279,409

(22) Filed: Jul. 24, 2025

Related U.S. Application Data
(60) Provisional application No. 63/675,653, filed on Jul. 25, 2024.

(51) Int. Cl. G01N 21/21; G01N 21/84

(52) U.S. Cl. CPC G01N 21/21; G01N 21/84; G01N 2021/8477

(57) ABSTRACT

Embodiments of the present disclosure relate to a method of optical device metrology and a device. The method includes introducing a light beam into an optical device during a first time period at an initial angle, the optical device including an anisotropic crystal optical substrate, the optical device including a first surface and a second surface, propagating the light beam through the optical device, the light beam including a transverse electric polarization light and a transverse magnetic polarization light, measuring a plurality of measurements, during the first time period, the plurality of measurements including a quantity of the transverse electric polarization light and the transverse magnetic polarization light transmitted from a plurality of locations on the first surface or the second surface during the first time period, wherein the measuring is performed by a detector, and using the measurements during the first time period to determine optical loss.

### CROSS-REFERENCE TO RELATED APPLICATION

This application claims the benefit of U.S. Provisional Patent Application No. 63/675,653, filed Jul. 25, 2024, which is incorporated by reference herein in its entirety.

### BACKGROUND

### Field

Embodiments of the present disclosure relate to optical devices. More specifically, embodiments of the present disclosure relate to a measurement system and a method to measure total light loss of an anisotropic crystal optical substrate.

### Description of the Related Art

Optical devices including waveguide combiners, such as augmented reality waveguide combiners, and flat optical devices, such as metasurfaces, are used to assist in overlaying images. Generated light is propagated through the optical device until the light exits the optical device and is overlaid on the ambient environment for the user to see.

Fabricated optical devices can lose light intensity through absorption and scattering as the light is propagated through the optical device. The optical devices are fabricated from optical substrates such as anisotropic crystal. Light loss from the optical substrate can be measured prior to fabricating an optical device. Single interaction measurement systems, such as spectroscopy systems, do not reliably measure the amount of light lost as light propagates through an optical device. Furthermore, it is challenging to measure low level light loss (e.g., light loss from an optical device due to scattering) with detectors of normal sensitivity. Additionally, it is difficult to determine whether the light loss is due to absorption or due to scattering.

Therefore, what is needed in the art is a measurement system and a method to measure total light loss in a substrate made of anisotropic crystal.

### SUMMARY

Embodiments of the present disclosure relate to optical devices. More specifically, embodiments of the present disclosure relate to a measurement system and a method to measure total light loss of an anisotropic crystal optical substrate.

In one embodiment, a method is provided. The method of optical device metrology including introducing a light beam into an optical device during a first time period, the optical device including an anisotropic crystal optical substrate, the optical device including a first surface and a second surface, propagating the light beam through the optical device, the light beam including a transverse electric polarization light and a transverse magnetic polarization light, and measuring a plurality of measurements, during the first time period, the plurality of measurements including a quantity of the transverse electric polarization light and the transverse magnetic polarization light transmitted from a plurality of locations on the first surface or the second surface during the first time period, wherein the measuring is performed by a detector.

In another embodiment, a method is provided. The method of optical device metrology including introducing a light beam into an optical device during a first time period at an initial angle, the optical device including an anisotropic crystal optical substrate, the optical device including a first surface and a second surface, propagating the light beam through the optical device, the light beam including a transverse electric polarization light and a transverse magnetic polarization light, measuring a plurality of measurements, during the first time period, the plurality of measurements including a quantity of the transverse electric polarization light and the transverse magnetic polarization light transmitted from a plurality of locations on the first surface or the second surface during the first time period, wherein the measuring is performed by a detector, and using the plurality of measurements during the first time period to determine optical loss.

In another embodiment, a device is provided. The optical device includes a substrate comprising an anisotropic crystal and having a first surface and a second surface, a waveguide combiner, the waveguide combiner having an incoupler and an outcoupler, the incoupler and the outcoupler are disposed over the first surface or second surface, wherein the waveguide combiner is operable to propagate a light beam through the optical device as transverse electric polarization light and transverse magnetic polarization light, and a detector operable to collect a scattered light as the scattered light contacts the optical device.

### BRIEF DESCRIPTION OF THE DRAWINGS

FIG. 1A is a schematic, cross sectional view of a configuration of a measurement system for transverse electric polarization light, according to certain embodiments.

FIG. 1B is a schematic, cross-sectional view of a configuration of a measurement system for transverse magnetic polarization light, according to certain embodiments.

FIG. 1C is a schematic, cross-sectional view of refraction angle differences of transverse magnetic polarization light and transverse electric polarization light in a substrate made of anisotropic crystal optical, according to certain embodiments.

FIG. 2 is a plot illustrating the percent of optical loss of transverse magnetic polarization light and transverse electric polarization light in a substrate made of anisotropic crystal optical, according to certain embodiments.

FIG. 3 is a flow diagram of a method to measure light loss of an anisotropic crystal optical device, according to certain embodiments.

FIG. 4 is a schematic, cross-sectional view of a waveguide, according to certain embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure relate to a measurement system and a method to measure total light loss of an anisotropic crystal optical substrate. The measurement system includes a light source configured to direct a light beam. The light beam includes transverse magnetic polarization light and transverse electric polarization light. The measurement system further includes a prism operable to direct the light beam into an optical device. The light beam(s) can propagate in the optical device between a first surface and a second surface for a length of the optical device. The measurement system includes a detector to perform a measurement (e.g., an intensity measurement) on the light loss from various points along one or more surfaces of the optical device. The light loss is measured and calculated as percent optical loss. The light beams are transverse magnetic polarization light and transverse electric polarization light. The light lost in the optical device can be controlled by controlling the incident angle of the light beams entering the optical device.

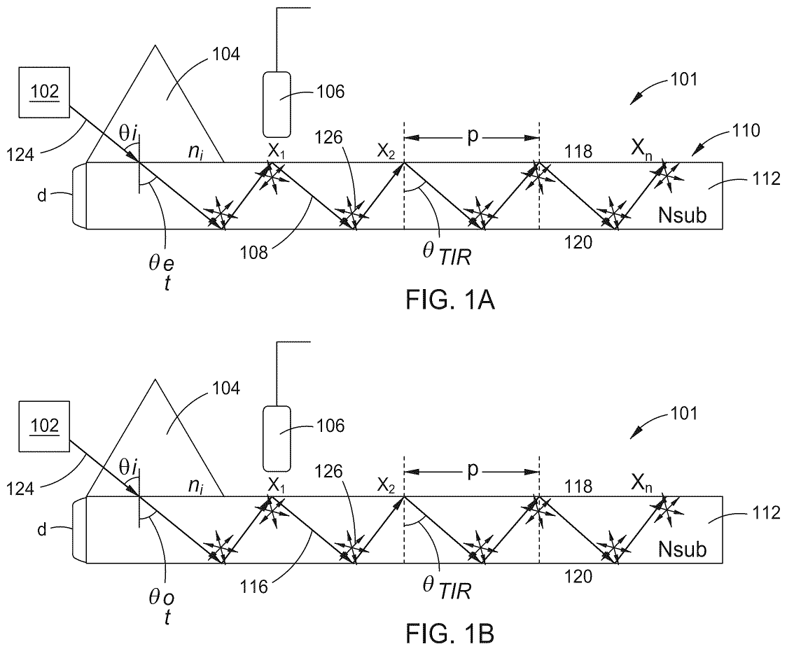

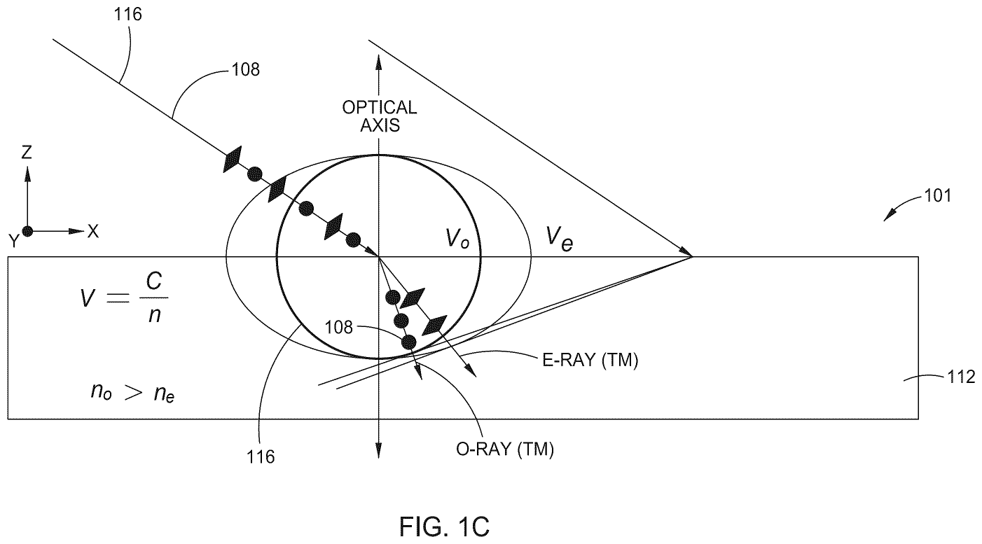

FIG. 1A is a schematic, cross sectional view of a configuration of a measurement system 101 for measuring transverse electric polarization light 108. FIG. 1B schematic, cross-sectional view of a configuration of a measurement system 101 for transverse magnetic polarization light 116. FIG. 1C is a schematic, cross-sectional view of refraction angle differences of transverse magnetic polarization light 116 and transverse electric polarization light 108 in a substrate 112. The substrate 112 is an anisotropic crystal. The anisotropic crystal is a uniaxial crystal, a biaxial crystal, or combinations thereof. The anisotropic crystal lithium niobium oxide (LiNbO₃), silicon carbide, or combinations thereof. The substrate 112 of the anisotropic crystal has a high refractive index of about 2.3 to about 2.7. The higher refractive index of the substrate 112 allows for a large field of view for the waveguide. The measurement system 101 includes a light source 102, a prism 104, and a detector 106. The light source 102 is operable to emit a light beam 124 into the optical device 110. When the light beam 124 enters the optical device it splits into two different beams: transverse electric polarization light 108 and transverse magnetic polarization light 116. As shown in FIG. 1A, the transverse electric polarization light 108 propagates the optical device 110. As shown in FIG. 1B, the transverse magnetic polarization light 116 propagates through the optical device 110. However, it is to be understood, as shown in FIG. 1C, that transverse electric polarization light 108 or transverse magnetic polarization light 116 propagate through the optical device 110 and the measurement system 101 simultaneously. The measurement system 101 is operable to determine the percent optical loss of an optical device 110 after light (e.g., transverse electric polarization light 108 or transverse magnetic polarization light 116) is coupled into the optical device 110. In one or more embodiments, the measurement system 101 is operable to measure a plurality of measurements such as a quantity of the transverse electric polarization light and the transverse magnetic polarization light transmitted from a plurality of locations on the first surface or the second surface during the first time period. In one or more embodiments, the detector 106 is operable to conduct the plurality of measurements. The optical device 110 includes a first surface 118 and a second surface 120. The first surface 118 is a surface of the substrate, and the second surface 120 is a surface of the substrate, as shown in FIG. 1A and FIG. 1B. In varying embodiments, this optical device 110 may be a waveguide combiner, such as an augmented reality waveguide combiner or a microscale waveguide, or a flat optical device, such as metasurface.

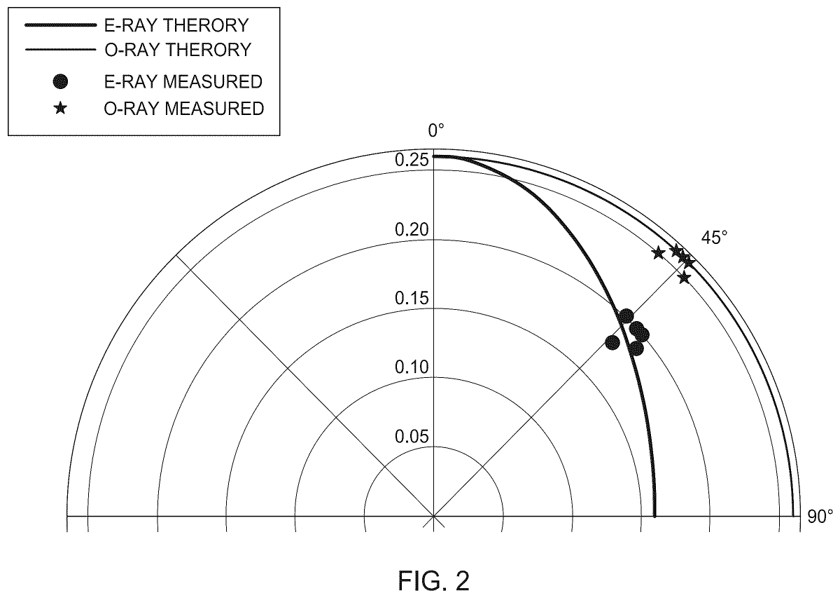

FIG. 2 is a plot illustrating the percent of optical loss of transverse magnetic polarization light 116 and transverse electric polarization light 108 in a substrate 112 versus the total internal rotation angle (TIR). The optical loss of the transverse electric polarization light 108 (e.g., o-ray) does not change with the angle of the transverse electric polarization light 108. The optical loss of the transverse electric polarization light 108 is calculated is calculated by using n_{sub}=nₒ and

$$sin {θ}_{t}^{o} = \frac{{n}_{i} sin {θ}_{i}}{{n}_{o}} .$$

In comparison, the optical loss of the transverse magnetic polarization light 116 (e.g., e-ray) changes with the incident angle of the transverse magnetic polarization light 116. The optical loss of the transverse magnetic polarization light 116 is calculated by using

$${n}_{sub} = \frac{1}{\sqrt{\frac{{cos}^{2} {θ}_{t}^{e}}{{n}_{o}^{2}} + \frac{{sin}^{2} {θ}_{t}^{e}}{{n}_{e}^{2}}}}$$

and tan

$${θ}_{t}^{e} = \frac{{n}_{e} \cdot {n}_{i} sin {θ}_{i}}{{n}_{o} \sqrt{{n}_{e}^{2} - {( {n}_{i} sin {θ}_{i} )}^{2}}} .$$

Further, the θ_{TIR} is calculated by using

$${θ}_{TIR} = {tan}^{- 1} \frac{P}{2 d}$$

where p is the propagation length detected from the surface between two peaks and d is the thickness of the substrate 112.

As shown in FIG. 2, as the incident angle changes, the percent optical loss of the transverse electric polarization light 108 remains constant. The percent optical loss of the transverse electric polarization light 108 is about 0.25% to about 0.26%. In contrast, as shown in FIG. 2, as the incident angle changes, the percent optical loss of the transverse magnetic polarization light 116 varies according to the Inc. angle. The percent optical loss of the transverse magnetic polarization light 116 is about 0.18% to about 0.20%. The incident angle may be adjusted by adjusting the initial angle of the light beam 124 as it enters the optical device 110.

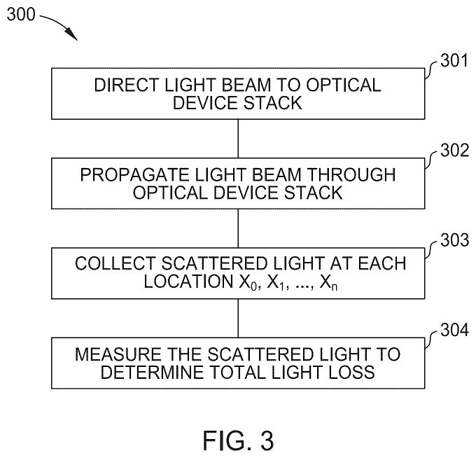

FIG. 3 is a flow diagram of method 300 of optical device metrology to measure percent optical loss of an optical device 110. The method is operable to be performed with one or more configurations described in FIGS. 1A-1C.

At operation 301, the light source 102 directs a light beam 124 to the optical device 110, which includes a substrate 112. The light beam 124 separates into two separate beams of light: the transverse electric polarization light 108 and the transverse magnetic polarization light 116.

In one embodiment, which can be combined with other embodiments described herein, the light beam 124 is coupled into the optical device 110 via the prism 104. In another embodiment, which can be combined with other embodiments described herein, the light beam 124 is coupled into the optical device 110 via a grating (not shown). The light beam 124 is incident on the optical device 110 at a TIR angle, θ_{TIR}.

At operation 302, the light beam 124 propagates through the optical device 110 as transverse electric polarization light 108 and transverse magnetic polarization light 116. The light beam 124 enters the optical device 110 at an initial angle θᵢ. Once inside the optical device the transverse electric polarization light 108 and the transverse magnetic polarization light 116 propagate through the optical device and contacts the optical device at various points according to a first optical device angle. The transverse electric polarization light 108 includes a first optical device angle

$${θ}_{t}^{o} .$$

The trasnverse magnetic polarization light 116 includes a first optical device angle

$${θ}_{t}^{e} .$$

As the trasnverse electric polarization light 108 and the transverse magnetic polarization light 116 propagates through the optical device the total internal reflection (TIR) angle, θ_{TIR}, determines the contact points along the optical device. The angles at which the transverse electric polarization light 108 and the transverse magnetic polarization light 116 contact the optical device 110 cause different levels of scattered light 126 to occur. The angles at which the transverse electric polarization light 108 and the transverse magnetic polarization light 116 contact the optical device can be adjusted by adjusting the initial angle θᵢ of the light beam 124 enters the optical device 110.

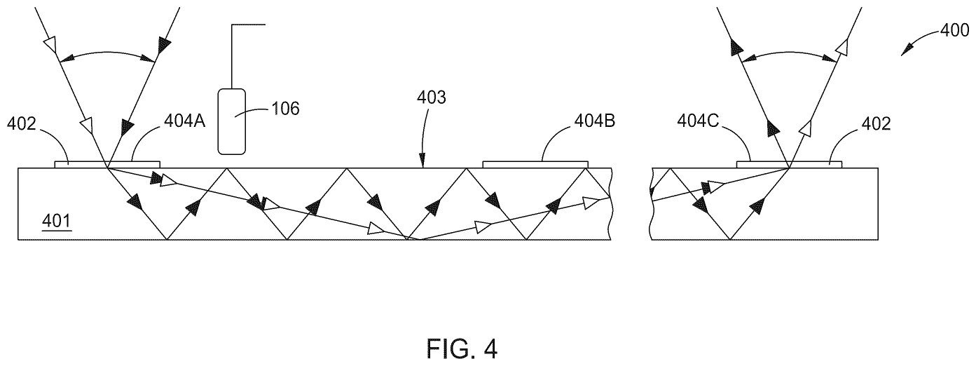

At operation 303, the detector 106 collects the scattered light 126 as the scatter light contacts the optical device 110 at points such as X₀, X₁, or Xₙ for a set period of time (e.g., a first time period or a second time period). As the signal of the scattered light 126 decays the detector 106 collects the signal decay as light loss data. In some embodiments, a length of the detector 106 moves along the optical device 110. For example, as shown in FIG. 4, the detector 106 is operable to collect the scattered light 126 as the scattered light 126 contacts the optical device 110.

At operation 304, the detector 106 collects the signal decay of the scattered light 126. The signal decay measurements can then be used to determine the total optical loss for the optical device 110. The optical loss is dependent on the incident angle and light polarization. In some embodiments, signal decay measurements performed on the substrate 112 only can be used to determine the total optical loss caused by the substrate 112 (i.e., α_{bulk}) as described in reference to this equation log I_{N}=log I₀−(α_{bulk}*X)*N.

Then, the magnitude between successive peaks and troughs in the signal decay measurements can be used to determine a relative amount of optical loss due to scattering with high magnitudes between successive peaks and troughs indicating high scattering and a corresponding low magnitude indicating lower amounts of scattering. If high scattering is identified, then the incident angle of the light beam 124 can be adjusted to control the light lost due to scattering. In certain embodiments, method 300 is repeated during a second time period, a third time period, etc. The signal decay measurements are used to determine optical loss.

FIG. 4 is cross-sectional view of a waveguide 400. It is to be understood that the waveguide 400 described herein is an exemplary waveguide and that other waveguides may be used with or modified to accomplish aspects of the present disclosure. The waveguide 400 includes a plurality of structures 402. The structures 402 may be disposed over, under, or on a surface 403 of a substrate 401, or disposed in the substrate 401. The structures 402 are nanostructures have a sub-micron critical dimension (e.g., a width less than 1 micrometer). Regions of the structures 402 correspond to one or more gratings (not pictured). In one embodiment, which can be combined with other embodiments described herein, the waveguide 400 includes at least an incoupler 404A (e.g., a first grating) and an outcoupler 404C (e.g., outcoupler grating). In another embodiment, which can be combined with other embodiments described herein, the waveguide 400 further includes an intermediate grating 404B. The intermediate grating 404B corresponds to a pupil expansion grating (“pupil expander”) or a fold grating.

In operation, the incoupler 404A receives incident beams of light having an intensity from a light engine. The incident beams are split by the structures 402 into T1 beams that have all of the intensity of the incident beams in order to direct a virtual image to the intermediate grating (if utilized) or to the outcoupler 404C. In one embodiment, which can be combined with other embodiments described herein, the T1 beams undergo total-internal-reflection (TIR) through the waveguide 400 until the T1 beams come in contact with the structures 402 of the intermediate grating. The structures 402 of the intermediate grating diffract the T1 beams to T−1 beams that undergo TIR through the waveguide 400 to the structures 402 of the outcoupler 404C. The structures 402 of the outcoupler 404C outcouple the T1 beams to the user's eye. The T1 beams outcoupled to the user's eye display the virtual image produced from the light engine from the user's perspective and further increase the viewing angle from which the user can view the virtual image. In another embodiment, which can be combined with other embodiments described herein, the T1 beams undergo total-internal-reflection (TIR) through the waveguide 400 until the T1 beams come in contact with the structures 402 of the outcoupler 404C and are outcoupled to display the virtual image produced from the light engine.

Embodiments of the present disclosure relate to a measurement system and a method to measure total light loss of an anisotropic crystal optical substrate. A light beam entering the anisotropic crystal optical substrate splits into a transverse electric polarization light and a transverse magnetic polarization light. The measurement system is operable to measure the scattered light of both the transverse electric polarization light or transverse magnetic polarization light as the transverse electric polarization light or transverse magnetic polarization light propagates through the optical device. The measurements enable an assessment of how much light is lost due to light scattering. Determining the light lost in the optical device allows for the light beam to be controlled according to the initial angle of the light beam entering the optical device. Thus, reducing the amount of light lost in the optical device.

While the foregoing is directed to embodiments of the present disclosure, other and further embodiments of the disclosure may be devised without departing from the basic scope thereof, and the scope thereof is determined by the claims that follow.

What is claimed is:

1. A method of optical device metrology comprising:
introducing a light beam into an optical device during a first time period, the optical device comprising an anisotropic crystal substrate, the optical device including a first surface and a second surface;
propagating the light beam through the optical device, the light beam including a transverse electric polarization light and a transverse magnetic polarization light; and
measuring a plurality of measurements, during the first time period, the plurality of measurements comprising a quantity of the transverse electric polarization light and the transverse magnetic polarization light transmitted from a plurality of locations on the first surface or the second surface during the first time period, wherein the measuring is performed by a detector.

2. The method of claim 1, further comprising using the plurality of measurements during the first time period to determine an optical loss of the transverse electric polarization light.

3. The method of claim 1, further comprising using the plurality of measurements during the first time period to determine an optical loss of the transverse magnetic polarization light.

4. The method of claim 1, wherein the anisotropic crystal substrate comprises lithium niobium oxide, silicon carbide, or combinations thereof.

5. The method of claim 1, wherein the anisotropic crystal substrate includes a refractive index of about 2.3 to about 2.7.

6. The method of claim 1, wherein the optical device is a waveguide combiner.

7. The method of claim 1, further comprising:
introducing the light beam into the optical device during a second time period;
propagating the light beam through the optical device, the light beam including the transverse electric polarization light and the transverse magnetic polarization light; and
measuring, during the second time period, the quantity of the transverse electric polarization light and the transverse magnetic polarization light transmitted from the plurality of locations on the first surface or the second surface during the first time period, wherein the measuring is performed by the detector.

8. The method of claim 1, wherein the detector is operable to collect a signal decay as a light loss data.

9. The method of claim 1, further comprising:
adjusting an initial angle to control an optical loss within the optical device.

10. A method of optical device metrology comprising:
introducing a light beam into an optical device during a first time period at an initial angle, the optical device comprising an anisotropic crystal substrate, the optical device including a first surface and a second surface;
propagating the light beam through the optical device, the light beam including a transverse electric polarization light and a transverse magnetic polarization light;
measuring a plurality of measurements, during the first time period, the plurality of measurements comprising a quantity of the transverse electric polarization light and the transverse magnetic polarization light transmitted from a plurality of locations on the first surface or the second surface during the first time period, wherein the measuring is performed by a detector; and
using the plurality of measurements during the first time period to determine a optical loss of the transverse electric polarization light and the optical loss of the transverse magnetic polarization light.

11. The method of claim 10, further comprising:
introducing the light beam into the optical device during a second time period;
propagating the light beam through the optical device, the light beam including the transverse electric polarization light and the transverse magnetic polarization light; and
measuring, during the second time period, the quantity of the transverse electric polarization light and the transverse magnetic polarization light transmitted from the plurality of locations on the first surface or the second surface during the first time period, wherein the measuring is performed by the detector.

12. The method of claim 10, further comprising:
adjusting the initial angle to control the optical loss of the transverse electric polarization light and the optical loss of the transverse magnetic polarization light within the optical device.

13. The method of claim 10, wherein the anisotropic crystal substrate comprises lithium niobium oxide, silicon carbide, or combinations thereof.

14. The method of claim 10, wherein the anisotropic crystal substrate comprises a high refractive index of about 2.3 to about 2.7.

15. The method of claim 10, wherein the detector is operable to collect a signal decay as a light loss data.

16. An optical device comprising:
a substrate comprising an anisotropic crystal and having a first surface and a second surface;
a waveguide combiner, the waveguide combiner having an incoupler and an outcoupler, the incoupler and the outcoupler are disposed over the first surface or second surface, wherein the waveguide combiner is operable to propagate a light beam through the optical device as transverse electric polarization light and transverse magnetic polarization light; and
a detector operable to collect a scattered light as the scattered light contacts the optical device.

17. The optical device of claim 16, wherein the detector is operable to move along a length of the optical device.

18. The optical device of claim 16, wherein the anisotropic crystal comprises a uniaxial crystal, a biaxial crystal, or combinations thereof.

19. The optical device of claim 16, wherein the anisotropic crystal comprises lithium niobium oxide, silicon carbide, or combinations thereof.

20. The optical device of claim 16, wherein the anisotropic crystal comprises a high refractive index of about 2.3 to about 2.7.
